(19) United States
(12) Patent Application Publication
(10) Pub. No.: US 2007/0273592 A1
(43) Pub. Date: Nov. 29, 2007

(54) Antenna structure and method of manufacturing antenna

(75) Inventor: Bong Kuk Hong, Osan City (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/798,266

(22) Filed: May 11, 2007

(30) Foreign Application Priority Data
May 16, 2006 (KR) 10-2006-0043931

(51) Int. Cl. H01Q 1/24

(52) U.S. Cl. 343/702

(57) ABSTRACT

The present invention relates to an antenna structure in which an antenna pattern is formed on an inner surface of a case of a terminal device, and a method of manufacturing an antenna. In the present invention, an optimal antenna pattern is shaped in accordance with a frequency characteristic of a terminal device and the antenna pattern is directly printed on an inner surface of the terminal device through a vacuum evaporation or sputtering method. At this time, a mask member having the same shape as that of the antenna pattern is further provided. Alternatively, a transfer paper with the antenna pattern printed thereon may be attached to the inner surface of the terminal device. Therefore, even a complex antenna pattern can be easily implemented in the terminal device. Further, an optimal antenna characteristic can be obtained since the antenna is spaced apart from a printed circuit board by a predetermined distance.

### BACKGROUND

1. Field of the Invention

The present invention relates to an internal antenna, and more particularly, to an antenna structure in which an antenna pattern is formed on an inner surface of a case of a terminal device, and a method of manufacturing an antenna.

2. Description of the Related Art

In general, an antenna for data transmission and reception is essential in order to perform a function such as Bluetooth corresponding to a typical local area wireless communication, a wireless local area network (WLAN), a global system for mobile communication (GSM) or code division multiple access (CDMA) in a terminal device such as cellular phone, PDA or PMP. The antenna should be able to provide an almost omnidirectional radiation pattern and a relative high gain and bandwidth. Further, in order to implement a multi-band and multi-mode operation, various bands should be able to be easily implemented. In this case, it is technically important to design an antenna such that small differences in performance (gain, relative band width, radiation pattern and the like) between bands are generated.

Various forms of the antennas have been supported. Heretofore, a straight whip antenna made of a metal rod wire, a helical antenna made of a metal rod wire and a telescopic antenna have been utilized. However, an internal antenna (hereinafter, referred to as an antenna) which can be installed in a terminal device is employed to satisfy the desires of consumers in accordance with the trend of miniaturization for the consumers to have a small-sized terminal device.

A planar inverted F antenna (PIFA) in which a power feed line is formed at a predetermined position of a metal device having a predetermined shape is widely used as an internal antenna. Since the PIFA is insert injection molded on a separate structure, it can be manufactured in a predetermined pattern by which optimal antenna characteristics are implemented.

As shown in FIG. 1, however, since an antenna pattern 3 is manufactured on a structure 1 through the injection molding, it was difficult to process or correct the resultant antenna. Accordingly, in a case where a pattern should be corrected due to a change of an antenna characteristic, it is difficult to perform an active design change for tuning and the manufacturing costs are high. Further, there are problems in that the injection molding causes an increase of a defective proportion and the mold costs are incurred because molds for the injection molding should be manufactured.

Moreover, although an optimal antenna characteristic is provided, the antenna is installed to be spaced apart from a printed circuit board (PCB) by a certain distance. Therefore, there was a limitation in minimizing the size of a terminal device since an installation space should be secured.

Another example of an internal antenna corresponds to a case where an antenna is formed on a printed circuit board. That is, as shown in FIG. 2, an antenna pattern 13 may be formed on a printed circuit board 11. In this case, however, there is another problem in that the antenna pattern 13 may be influenced by noise produced in the other components mounted on the printed circuit board 11 or may interfere with the other components. To solve the problem, a shielding film for protecting the antenna should be additionally formed. Further, since the antenna is formed directly on the printed circuit board, a new printed circuit board should be manufactured again for correction and tuning. Therefore, additional works are required and the associated costs are thus increased.

### SUMMARY

The present invention is conceived to solve the aforementioned problems in the prior art. An object of the present invention is to provide an antenna structure in which an optimal antenna pattern is formed on an inner surface of a terminal device, and a method of manufacturing an antenna.

According to an aspect of the present invention for achieving the object, there is provided an antenna structure in which an antenna pattern having a predetermined shape and thickness is printed on an inner surface of a case of a terminal device.

Preferably, a power feed line and a ground line are connected between the antenna pattern and a printed circuit board of the terminal device.

The shape of the antenna pattern may be changed according to frequency characteristics of the terminal device.

The antenna pattern may be printed using a vacuum evaporation or sputtering method.

The antenna structure may further comprise a mask member having the same shape as that of the antenna pattern. Preferably, in a state where the mask member are spaced apart from the terminal device by a predetermined distance, a metallic material is evaporated onto and adheres to the inner surface of the case through the mask member.

According to another aspect of the present invention, there is provided an antenna structure in which an antenna pattern having a predetermined shape and thickness is printed through a vacuum evaporation method on an inner surface of a case of a terminal device.

According to a further aspect of the present invention, there is provided an antenna structure in which an antenna pattern having a predetermined shape and thickness is printed through a sputtering method on an inner surface of a case of a terminal device.

According to a still further aspect of the present invention, there is provided an antenna structure in which a transfer paper with an antenna pattern having a predetermined shape and thickness printed thereon is attached to an inner surface of a case of a terminal device.

According to a still further aspect of the present invention, there is provided a method of manufacture an antenna, comprising the steps of shaping an antenna pattern in accordance with a characteristic of a terminal device; fixedly installing a mask member at a distance from an inner surface of a case of the terminal device, the mask member having the same shape as that of the antenna pattern; and printing the antenna pattern on the inner surface of the case.

The antenna pattern may be printed through a vacuum evaporation or sputtering method.

The antenna pattern may have a predetermined thickness in accordance with a frequency characteristic of the terminal device.

According to a still further aspect of the present invention, there is provided a method of manufacturing an antenna, comprising the steps of printing an antenna pattern on a transfer paper; and attaching the transfer paper to an inner surface of a case of a terminal device.

According to the present invention so configured, the antenna pattern is formed on the inner surface of the case of the terminal device. Therefore, even though the antenna pattern is complex, an antenna structure can be easily implemented. Further, an influence of noise on the antenna structure can be reduced since the antenna pattern is spaced apart from a printed circuit board by a predetermined distance.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a perspective view of a conventional antenna obtained by insert injecting molding a metallic product to a separate structure;

FIG. 2 is a view showing the configuration of a product in which an antenna pattern is formed on a circuit board;

FIG. 3 is a view showing the configuration of an antenna structure according to a preferred embodiment of the present invention;

FIG. 4 is a view illustrating a process of forming the antenna structure of the present invention shown in FIG. 3 by printing an antenna pattern on an inner surface of a case of a terminal device; and

FIG. 5 is a view showing the configuration of an antenna structure according to another embodiment according to the present invention.

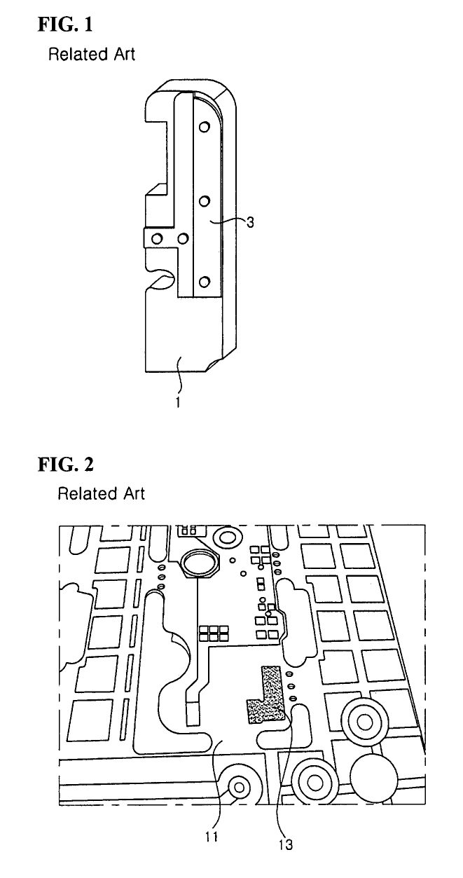

### DETAILED DESCRIPTION

Hereinafter, an antenna structure and a method of manufacturing an antenna according a preferred embodiment of the present invention will be described in detail with reference to the accompanying drawings.

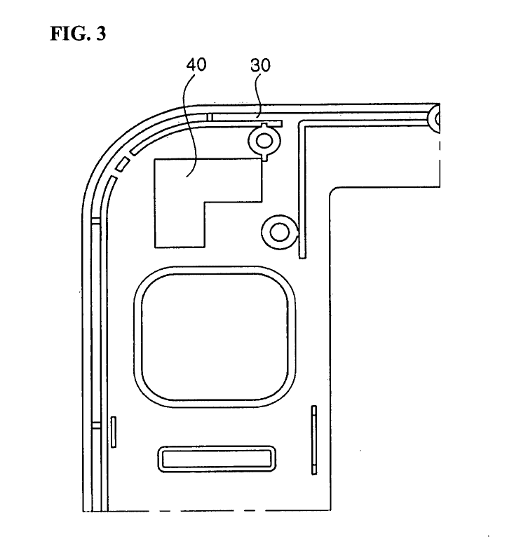

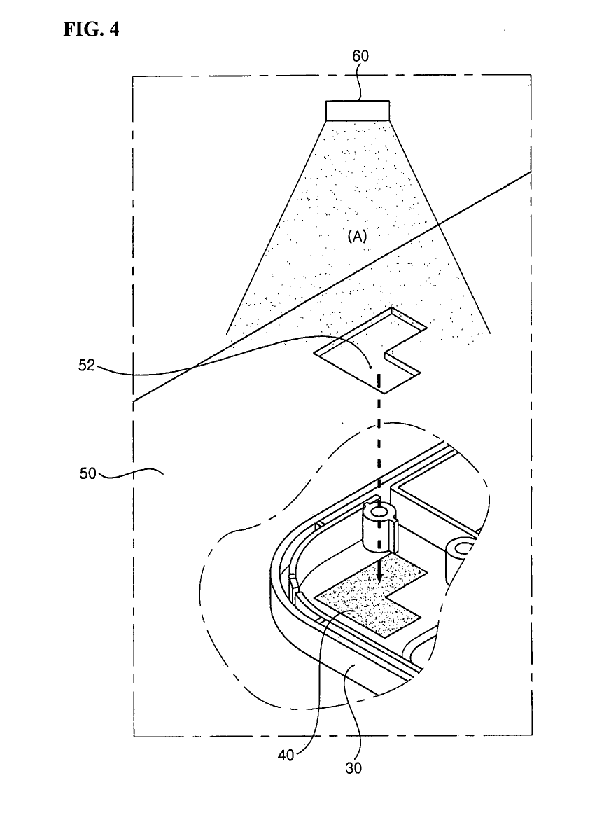

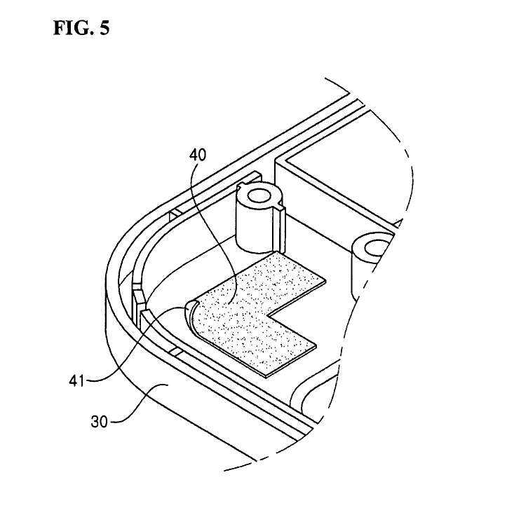

FIG. 3 is a view showing the configuration of an antenna structure according to a preferred embodiment of the present invention, and FIG. 4 is a view illustrating a process of forming the antenna structure of the present invention shown in FIG. 3 by printing an antenna pattern on an inner surface of a case of a terminal device.

Referring to FIGS. 3 and 4, it can be understood that an antenna pattern 40 is printed on an inner surface of a case 30 of a terminal device. The antenna pattern 40 has different shapes according to frequency characteristics of various wireless communication methods such as Bluetooth, WLAN, GSM or CDMA. Accordingly, the antenna pattern 40 should be formed into a pattern with an optimal antenna characteristic in consideration of the characteristics of a terminal device to which the wireless communication method is actually applied. When the antenna pattern 40 is formed, a shape of the inner surface of the case 30 in the terminal device on which the antenna pattern 40 is actually printed is also considered. In this embodiment of the present invention, the L-shaped antenna pattern 40 is printed on the inner surface of the case 30.

Next, a process of printing the antenna pattern 40 on the inner surface of the case 30 will be described.

First, as described above, an antenna pattern is shaped through a tuning process of providing optimal frequency characteristics. After the antenna pattern 40 is determined, it is printed on the inner surface of the case 30 of a terminal device. At this time, the antenna pattern 40 may be directly printed through a general printing method, but it is described in the present invention that the antenna pattern 40 is printed through a vacuum evaporation or sputtering method. In other words, the case 30 of the terminal device, most of which is made of a plastic material, has an insulation property but has low flame resistance and low adhesion force when coated, since the plastic material is electrically neutral due to a chemical structure thereof. Accordingly, when a film is coated on the case 30 through a conventional wet or spray coating method, its thickness may not be uniform and a coating layer may be separated as time goes by.

A case where the antenna pattern 40 is printed using the vacuum evaporation method will be first explained with reference to FIG. 4.

In the vacuum evaporation method, an object to be coated and metallic particles to be attached to a surface of the object are provided in a vacuum chamber, and heated using a heater such that the metallic particles are evaporated and then condensed on and attached to the surface of the object.

To more effectively perform the vacuum evaporation method, plasma treatment is performed on the inner surface of the case 30 and specifically on a portion where the antenna pattern 40 will be printed, so that a physical adhesion force can be enhanced. Next, a mask member 50 is patterned to have the same pattern as that of the antenna pattern 40. The mask member 50 is formed with a pattern 52 corresponding to the antenna pattern 40.

When the mask member 50 formed with pattern 52 therein is prepared, the mask member 50 is spaced apart from the inner surface of the case 30 by a predetermined distance. Although not shown in the drawings, the case 30 is fixed by a separate fixing means in a state where the inner surface thereof faces upward. Simultaneously, the mask member 50 is kept by a support device at a state where it is spaced apart from the inner surface of the case.

Next, if the evaporated metallic particles are provided from a certain housing 60 toward the mask member 50, they pass through the pattern 52 formed in the mask member 50 and then reach a predetermined position on the inner surface of the case and are finally printed on the inner surface of the case.

At this time, a thickness of the antenna pattern 40 is determined in consideration of an optimal radiation characteristic. Here, the thickness of the antenna pattern 40 can be optimally adjusted by suitably setting the degree of vacuum in the chamber, and the printing time and the current amplitude in a state where a gap between a metallic material supply source and the case 30 is kept constant.

After the antenna pattern 40 has been printed, a power feed line and a ground line are connected between a printed circuit board mounted and the antenna pattern 40 on the case 30 using a connection pin (not shown) having a predetermined material property. It is preferred that the connection pin be elastic to prepare against shock and motion applied thereto.

Another case where the antenna pattern 40 is printed using the sputtering method will be explained.

In general, the sputtering method includes performing the emission of target atoms and causing the atom to adhere to the case. That is, if metal is heated under vacuum to chemically modifying a material such as metal, plastic or glass using a principle that the metal can be easily evaporated, the metal is evaporated and scattered to be formed into a metallic thin film on the material (i.e., the case) under vacuum.

As used in the aforementioned vacuum evaporation method, a vacuum chamber is also used in the sputtering method. In general, if a direct current power of about 1 W per cm² is applied to a target (cathode) while providing low-pressure sputtering gas, i.e. argon gas in the chamber, plasma is generated between the target and the case to be deposited. Further, in the plasma, the argon gas is ionized into a positive ion by a high-power DC amperemeter.

Moreover, the positive argon ion is accelerated toward the cathode by the DC amperemeter to bombard a surface of the target, and an atom of the target emitted by bombardment energy adheres to the inner surface of the case.

Through the above processes, the antenna pattern 40 can be printed on the inner surface of the case 30.

FIG. 5 is a view showing the configuration of an antenna structure according to another embodiment according to the present invention.

The antenna structure of this embodiment corresponds to a case where the antenna pattern 40 is printed on and attached to a transfer paper 41.

The transfer paper 41 is configured such that it can easily adhere to the inner surface of the case 30 using an adhesive material provided at one side of the transfer paper 41. First, the antenna pattern 40 is printed on the transfer paper 41 using a vacuum evaporation or sputtering method. Then, one side of the transfer paper 41 on which the antenna pattern 40 is printed (i.e., a side on which an adhesive material is provided) adheres to the inner surface of the case 30.

Further, the antenna pattern 40 has a predetermined thickness in accordance with a frequency characteristic of a terminal device.

As described above, it can be understood that according to the present invention, an antenna pattern is directly formed on an inner surface of a case in a terminal device in consideration of a frequency characteristic thereof.

For example, in the present invention, an antenna pattern with a predetermined shape and thickness is printed on an inner surface of a case of a terminal device made of a plastic material through a vacuum evaporation or sputtering method. However, the present invention may be applied to a material such as a synthetic resin, and the antenna pattern of the present invention may be printed through the other printing methods.

As described above, since an antenna pattern is provided through a printing method, it can be easily implemented into a terminal device even though it is complex. Therefore, there is an advantage in that an antenna pattern optimized by frequency characteristics can be provided.

Further, since the antenna pattern of the present invention is spaced apart from a printed circuit board by a predetermined distance, it is less influenced by noise as compared with a related art in which the antenna pattern is implemented on the printed circuit board. Accordingly, an initially set antenna characteristic can be correctly provided and various kinds of parts/devices mounted to the printed circuit board can be stably operated.

Furthermore, even though the antenna pattern is changed, an antenna can be easily manufactured by merely forming the changed antenna pattern onto a mask member. As a result, there is another advantage in that the time and costs can be reduced.

Although the present invention has been described in connection with the preferred embodiments, they are only for illustrative purposes. It will be readily understood by those skilled in the art that various modifications, changes and equivalents can be made thereto without departing from the spirit and scope of the present invention. Therefore, the true scope of the present invention should be defined by the technical spirit of the appended claims.

What is claimed is:

1. An antenna structure, wherein an antenna pattern having a predetermined shape and thickness is printed on an inner surface of a case of a terminal device.

2. The antenna structure as claimed in claim 1, wherein a power feed line and a ground line are connected between the antenna pattern and a printed circuit board of the terminal device.

3. The antenna structure as claimed in claim 1, wherein the shape of the antenna pattern is changed according to frequency characteristics of the terminal device.

4. The antenna structure as claimed in claim 1, wherein the antenna pattern is printed using a vacuum evaporation or sputtering method.

5. The antenna structure as claimed in claim 1, further comprising a mask member having the same shape as that of the antenna pattern, wherein in a state where the mask member are spaced apart from the terminal device by a predetermined distance, a metallic material is evaporated onto and adheres to the inner surface of the case through the mask member.

6. An antenna structure, wherein an antenna pattern having a predetermined shape and thickness is printed through a vacuum evaporation method on an inner surface of a case of a terminal device.

7. An antenna structure, wherein an antenna pattern having a predetermined shape and thickness is printed through a sputtering method on an inner surface of a case of a terminal device.

8. An antenna structure, wherein a transfer paper with an antenna pattern having a predetermined shape and thickness printed thereon is attached to an inner surface of a case of a terminal device.

9. A method of manufacture an antenna, comprising the steps of:
shaping an antenna pattern in accordance with a characteristic of a terminal device;
fixedly installing a mask member at a distance from an inner surface of a case of the terminal device, the mask member having the same shape as that of the antenna pattern; and
printing the antenna pattern on the inner surface of the case.

10. The method as claimed in claim 9, wherein the antenna pattern is printed through a vacuum evaporation or sputtering method.

11. The method as claimed in claim 9, wherein the antenna pattern has a predetermined thickness in accordance with a frequency characteristic of the terminal device.

12. A method of manufacturing an antenna, comprising the steps of:
printing an antenna pattern on a transfer paper; and
attaching the transfer paper to an inner surface of a case of a terminal device.
